(19) United States
(12) Patent Application Publication
(10) Pub. No.: US 2019/0332990 A1
(43) Pub. Date: Oct. 31, 2019

(54) Business Method for Reimbursing Costs Associated with Installing Advanced Water Metering Technology

(71) Applicant: Michael Edward Klicpera, La Jolla, CA (US)

(72) Inventor: Michael Edward Klicpera, La Jolla, CA (US)

(21) Appl. No.: 15/965,972

(22) Filed: Apr. 29, 2018

(51) Int. Cl. G06Q 10/06; G06Q 30/02

(52) U.S. Cl. CPC G06Q 10/06315; G06Q 50/06; G06Q 30/0234; G06Q 30/0206

(57) ABSTRACT

A business method of reimbursing water meter companies for the costs involved in installing smart or advanced water meters. The method includes that the water meter company negotiates with water municipalities/utilities to become responsible for the water use billing operations. In addition, some smart water meters will be able to alert property owners and users of leak conditions, which can be addressed by remote or automated water control. Furthermore, some smart water meters can include consumable or non-consumable water quality sensors and the replacement of the water quality sensors can be managed by the water company. The water meter company can provide service and maintenance for advanced or smart water meters such as software updates, battery replacements, and replacement of expired or nonfunction components. Furthermore, insurance companies have an interest in providing rebates or discounts to support the use of the smart water meters preventing leak and leak damage.

### FIELD OF THE INVENTION

The present invention relates generally to a business method associated with the installation of smart water meters or advanced water metering technology. More specifically, this invention relates to the reimbursement for installing smart water meters or advanced water metering technology by acquiring responsibility for the water billing operations, providing leak detection and alerting services, providing water quality sensor technology, providing maintenance services and/or securing insurance company rebates or payments.

### BACKGROUND OF THE INVENTION

The installation of smart electric meters and gas meters has been omnipresent and this has been due to several factors. First, the installing companies have profitable payment program to reimburse the installation of the electric or gas smart meters, and the standardization of electrical meters and gas meters facilitates the installation process.

But installation of smart water meters is complicated by the non-standard pipe size, different pipe materials, variations in couplers, and location and size of water meter boxes. Add the risk of water leaks after installation is another issue the requires close attention. Leaks cause considerable property damage and mold health issues that is a significant cost to home and corporate owners and insurance companies. And leaks do not always appear immediately after installation, but may begin subsequently. And leaks occur spontaneously due to bad installation techniques, inferior pipe components, and general wear and tear action of the plumbing components of a home or corporation.

There is also the issue that smart water meters or advanced water metering technology are still evolving and including new technology that, together with the disadvantages described, inhibits the installation of smart water meters or advanced water metering technology.

In addition, smart water meters or advanced water metering technology have wireless technology that may need software updates, servicing, and testing for functionality.

### SUMMARY OF THE INVENTION

The present invention relates to a business method of reimbursing companies for the costs involved in installing smart water meters or advanced water metering technology. This includes a first business method whereby the company with the smart water meters or advanced water metering technology negotiates with water municipality or water utility to become responsible for the billing operations of water use by residences and corporations. This will generate income on a monthly or bimonthly basis for the smart or advanced meter company to reimburse the cost of fabrication, delivery, distribution and installation of smart water meters or advance water metering technology. A second business method for companies that have a smart water meters or advanced water metering technology that have leak detection capability will be able to alert home owners and corporations of a catastrophic leak conditions, preferably on a real-time basis, and the company with smart water meters or advanced water metering technology can function like an alarm company, and have staff available, or use automatic computer technology, to contact home and corporate owners of the catastrophic leak condition and provide the option to turn off the water supply. The water meter company can generate income for such services to reimburse the cost of fabrication, delivery, distribution and installation of smart water meters or advance water metering technology. A third business method for only some smart water meters or advanced water metering technology that have consumable, replaceable or permanent water quality sensors with the smart water meter or advanced water metering technology and the replacement of the consumable or maintenance of permanent water quality sensors can be coordinated by the smart water company. This will be another method of generating income for the water company to reimburse the cost of fabrication, shipping and delivery, distribution and installation of smart water meters. A fourth business method for some smart water meters or advanced water metering technology have technology, such as software updates, battery replacement, replacing nonfunction components can be a service of the smart water company. This will also generate income for the smart water company to reimburse the cost of fabrication, shipping and delivery, distribution and installation of smart water meters. A fifth business method involved insurance companies have an interest in providing rebates or support financially smart water meters or advanced water metering technology that minimize leak damage which causes property damage and mold growth which has been a costly liability to insurance company. This fifth business method will require the water company to negotiate directly with the insurance company for reimbursement because traditionally the insurance company has a contractual relationship with the home owner.

Since these are business methods to generate income, the water company can reimburse its expenses for manufacturing, distribution, installation, and maintenance of smart water meters or advanced water metering technology. Eventually over a period, these expenses can be fully reimbursed and now the income generated can become unencumbered profits.

### BRIEF DESCRIPTION OF THE DRAWINGS

FIG. 1 is a perspective diagram showing the means of services and profits that can be generated from multiple service sources.

FIG. 2 is a perspective diagram showing the relationship between the reduction in liability for the insurance company due to the installation of a smart water meter or advanced water metering technology that has leak detection and correction capabilities.

FIG. 3 shows the profit over time in dollars when there is no water municipality investment but includes a one-time payment by an insurance company.

FIG. 4 shows the profit over time in dollars with a 25% water municipality investment and includes a one-time payment by an insurance company.

FIG. 5 shows the profit over time in dollars when there is no water municipality investment where the insurance company pays for one half of the product and product installation cost.

FIG. 6 shows the profit over time in dollars when there is a water municipality investment where the insurance company pays for one half of the product and product installation cost.

FIG. 7 shows the profit over time in dollar when there is no water municipality investment and the insurance company pays for the cost of the smart water meter or advance water metering technology.

FIG. 8 shows the profit over time in dollar when there is no water municipality investment and the insurance company pays for the cost of the smart water meter or advance water metering technology.

### DESCRIPTION OF THE PREFERRED EMBODIMENTS

Definitions of word or phrases to be used herein are presented below:

Residential home(s) and company refers to multi-unit apartment buildings, condominiums, hospitals, dormitories, commercial office buildings, homes, and the like.

The term company refers to the singular form of the word company as well as the plurality form of the word companies.

Smart water meter or advanced water meter technology refers to a residential and corporate water meters that has advanced metering and monitoring capability and may have real-time or similar leak detection with possible correction capabilities (e.g. remotely shout off the water supply). The smart water meter or advanced water metering technology will have wireless duplex or non-duplex communication with the property owner or user and/or the water municipality or water utility through a remote computer that is either privately developed and maintained computer system or utilize corporate cloud companies like Amazon Web Services, Microsoft Azure, and Google Cloud.

All numbers, cost, reimburse compensation described herein are exemplary and provided for describing how a smart meter is fabricated, delivered to a site and installed can be paid for by one or more of the described business methods. Furthermore, is in known that as adjustments in costs, negotiations and variability in needs between water utilities and/or water municipalities can impact the result of the reimbursement business method.

Water Billing Service

The water meter company having a smart water meter or advanced water metering technology will negotiate with water utilities or water municipalities to become partially or fully responsible for water use billing operations for private, business, and public properties. Water use data collected by water meter company utilized and transfer water use, water energy use, or water quality data and, if monitored, leak detection data to a privately developed and maintained remote computer system or utilize cloud service companies such as Amazon Web Services or Google Cloud, Microsoft Azure and stored on commercial databases for example MySQL, MariaSQL, Amazon Aurora, or DynamoDB (or a custom database with software support). The water meter company can generate and send custom billing reports directly from the privately developed and maintained remote computer system or the cloud service company to property owners/users with copies and summary reports to the water municipality or water utility. This efficient billing service will alleviate the cumbersome method of water use data collection and data processing and billing by municipalities, saving time, costs, and personnel resources. Resulting income generated from water billing services by the water meter company offsets device costs and can serve as an ongoing source of revenue for the water meter company.

Leak Management Service

If the water meter company has a smart water meter or advance water metering technology that has the capability to detect water leak conditions and can function to contact with and notify the property owner/user of any water leaks. Property water leaks are still a major percent of water use as it has been reported that 18% of total residential water use is due to water leaks. It is known that leaks of ten gallons or less per day make up 45% of total leaks and are these leaks are mostly undetected. The water meter company leak detection and notification service can function similar to an alarm service company. The water meter company may have the capability to also optionally provide the automated service to turn off the water supply to address any detected leak condition, thereby preventing water waste and property damage. For example, a property's water supply can be turned off and service immediately (by programmed instructions) or remotely upon the water meter company's detection and notification of any ongoing, large or potentially catastrophic leak. In another scenario, the water municipality or water utility can take on the responsibility for leak management services with royalty payment to the water meter company. Alternatively, existing property alarm or security service companies may, by contract, become responsible for leak management and add this service to its offered set of services for properties. Resulting income generated from leak management services by the water meter company offsets device costs and can serve as an ongoing source of revenue for the water meter company.

Property Insurance Compensation

Insurance expenses for property damage due to water leaks comprise a significant percentage of total liabilities. Insurance companies are already providing discounts or rebates to residential home owner policies for installed water leak detection devices. The water meter company's strategy is to secure property insurance discounts, rebates, and/or reimbursements for the installation and use of a smart water meter or an advanced water metering technology. Preferably, the water meter company, and possibly together with the water utility or water municipality, can negotiate with insurance companies to offer insurance policy reductions for property owners. Alternately, instead of reimbursement to the property owner, the water meter company will negotiate with the insurance companies to compensate the water meter company for installing an advanced water metering technology with leak detection. The offer to compensate the water meter company directly can be leveraged with a large-scale implementation plan, which would be advantageous to the insurance company. A main benefit to insurance companies is the significant reduction in liability associated with water damage. Resulting income generated from insurance compensation to the water meter company offsets device costs and can serve as an ongoing source of revenue for the water meter company.

Water Quality Monitoring

The use of water quality sensors with any smart water meter or advance water metering technology that has the capability to detect water quality utilizing pH sensors, total dissolved solids (TDS) sensors, heavy metals (e.g. lead) sensors, turbidity sensors, and other water quality sensors. The water quality sensors used with the smart water meter or advanced water metering technology can have the capability to provide water quality information that addresses both property specific and regional water problems. The distribution for sale and replacement of water quality sensors will generate consistent income for water meter company. Resulting income generated from installing and replacing water quality sensors by the water meter company offsets device costs and can serve as an ongoing source of revenue for the water meter company.

Water Meter Maintenance and Service

The water meter company with smart or advanced water metering technology will periodically require maintenance and service and including software updates, battery replacements, and replacement of any non-functional components. These maintenance and service activities may be handled by contractual arrangement between water meter company and the water municipality, or possibly be contracted with plumbing service companies. Resulting income generated from providing the water meter maintenance and service offsets device costs and can serve as an ongoing source of revenue for the water meter company.

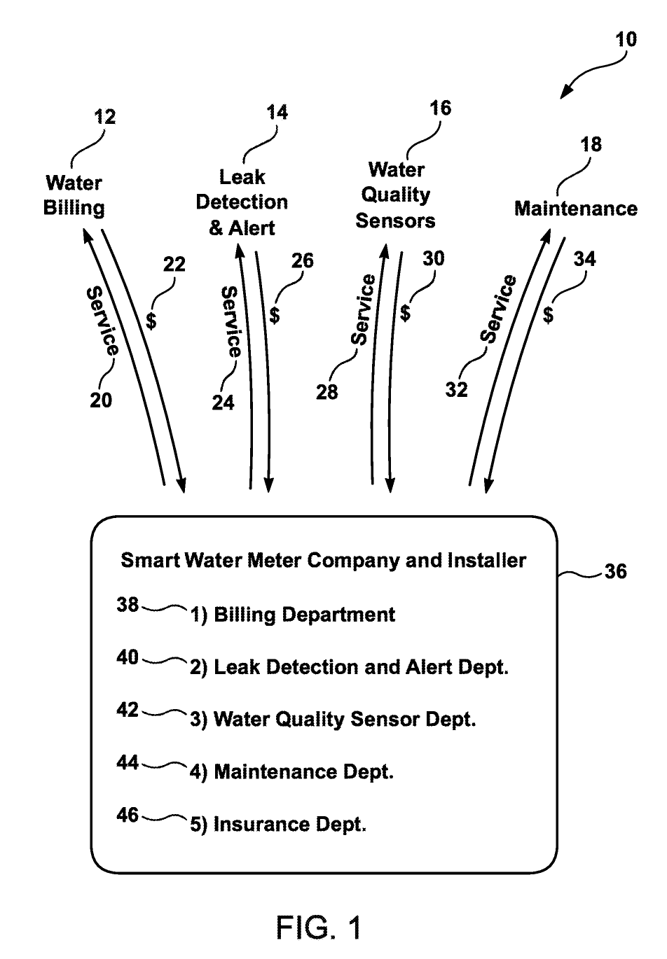

Now referring to FIG. 1, shown is a perspective diagram showing the means of services and profits that can be generated from multiple service sources 10. Shown in FIG. 1 is an arrow 20 demonstrating a billing service 12 going from the water meter company that is responsible for the billing service. Another arrow 22 shows compensation ($) provided to the water meter company for water billing services delivered. This represents that minor charge e.g. $1.00 are added to the water bill, or paid directly, for providing billing services 12. Bill services comprise collecting and processing water use data, calculating in accordance with current water municipalities or water utilities price per hundred cubic feet (HCF) which is equal to 748 gallons. Many water municipalities or water utilities are quasi-governmental organizations and to become responsible for the billing operations might take significant effort to persuade certain bureaucratic departments that this operation will be successful without any major problems as this is one of the main sources of income for the water municipality.

It is known that the expense to install a smart water meter within a water municipality can be cost prohibitive. For exemplary purposes only, if a smart water meter can be fabricated and installed for a total price of $300 for each unit and this example water municipality or water utility services 200,000 homes and corporations in its district. The cost of fabricating and installing the 200,000 smart water meters will cost approximately sixty million dollars ($60,000,000). This first business method includes the approach whereby the water meter company negotiates with water municipalities to become responsible for the billing operations of water use by residences and corporation. This could generate monthly income (e.g. $1) for the water meter company to reimburse the costs of manufacturing/fabrication, shipping and delivery, distribution and installation of smart water meters or advanced water metering technology. For purpose of an example, the assumption is that the water meter company becomes responsible for the billing procedures 12 and the water meter company is allowed by the municipality governing agency to charge on each bill for $1.00 for collecting, processing and generating each monthly bill. So then for a municipality of 200,000 home residences and corporations would generate $200,000 minus cost of conduct the billing procedures. The meter company can save mailing expenses by sending most, if not all, bills by email or Short Message Service (SMS) text. If the expense of performing the monthly water bills is $50,000, then the smart water company will profit $150,000 per month or $1,800,000 per year. At this rate, if no other compensation is obtained (e.g. an investment by the water municipality or water utility of $20,000,000 to pay for the smart meters or advanced water metering technology and installation cost to promote water conservation), it would take 33.3 year for the water meter company to be reimbursed for its costs in fabricating and installing the smart water meter. If the water meter company obtains $20,000,000 from the water municipality or water utility than it would reduce the reimbursement period to 22.2 years

Also shown in FIG. 1 is an Leak Detection and Alert Service with an arrow demonstrating a leak detection and alert 14 service 24 for property owners and users going from the water meter or advance water metering technology company 36 that provides the leak detection and alert services. Another arrow 26 shows compensation ($) being provided to the water meter company for the leak detection services delivered. This represents that costs (e.g. $0.75) are added to the water bill, or paid directly, for providing leak alert services 24.

Some smart water meters will be able to alert home owners and corporations of a catastrophic leak condition(s) and the water company can function like an alarm company, and have staff available, or utilize automatic computer technology, to contact home and corporate owners of the catastrophic leak condition and provide the option to turn off the water supply 14. These services will perform like a security alarm company with a few modifications. Alerts will not be sent to local police departments but rather directly to home owners and corporate representatives and/or the supplying water municipality or water utility. The water meter company will be able provide the option to the home owner or corporate representative to remotely turn off the water at the site where the leak condition is observed. The water meter company can generate income for such services. For example, if providing the leak condition and alert services 24, and the meter company is allowed by the municipality governing agency to increase each monthly bill for $0.75 generating for each property. So then for a municipality of 200,000 home residences and corporations would generate $150,000 per month minus cost of conduct the leak alert procedures. The water meter company can send the leak alerts by sending an email or Short Message Service (SMS) text to the cell phone or computer of a home owner, corporate representative and/or water municipality. Providing alert services can generate without human interaction, or can be monitored by individuals, or a combination of human involvement and computer automation. This example of the leak detection and alerting service would generate $1,800,000 per year. If the expenses of performing the leak alert costs $25,000 per month, then the smart water company will profit $125,000 per month or $1,500,000 per year. At this rate, if no other compensation is obtained (e.g. an investment by the municipality of $20,000,000 to pay for the smart meters or advanced water metering technology and installation cost to promote water conservation), the water billing can make a profit of 1,500,000 per year. If the costs are only attributed to only the water meter company, it would take 40.0 years for the water meter company to be reimbursed for its costs in fabricating and installing the smart water meter or advanced water metering technology. If the water meter company obtains $20,000,000 from the municipality than it would reduce the reimbursement period to 26.67 years.

By adding the $1,800,000 profit by conducting the billing services to the $1,500,000 for leak alert services amounts to a profit of $3,300,000 per year. At this rate, if no other compensation is obtained (e.g. an investment by the municipality of $20,000,000 to pay for the smart meters or advanced water metering technology and installation cost to promote water conservation), it would take 18.2 years for the water meter company to be reimbursed for its costs in fabricating and installing the smart water meter or advanced water metering technology. If the water meter company obtains $20,000,000 from the municipality than it would reduce the reimbursement period to 12.1 years.

Further shown is an arrow demonstrating a water quality sensor service 28 going from the water meter company 36 that has the capability to have water quality sensors 16 available with the smart water meter or advanced water metering technology. Another arrow show compensation ($) 30 from the water meter company 36 or designate that is providing water quality sensor services 28. This represents that costs are added to the monthly water bill, or paid directly, for providing water quality sensors 16.

If a water meter companies can include some consumable water quality sensors with the smart water meter or the advanced water metering technology and the replacement of the consumable water quality sensors can be coordinated by the water company or to a designated plumbing or other company. This will be another method of generating income for the water company. It is anticipated that only a percentage of the 200,000 home and corporate owners participate in the water quality sensor program. As an example, and by assuming that 10% (20,000 homes) participate in the and water sensor program on a monthly service, then directly charging each participating home owner a monthly fee of $50 and the cost of the program is estimated to be $25 per home, then the water meter company can generate $6,000,000 per year.

By adding the $1,800,000 profit by conducting the billing services, and the $1,500,000 for leak detection and alert services, to the $6,000,000 for water quality sensor services, which amount to a profit of $9,300,000 per year. At this rate, if no other compensation is obtained e.g. an investment by the water municipality or water utility of $20,000,000 to pay for the smart meters or advanced water metering technology and installation cost to promote water conservation. If the costs are attributed to only the meter company, it would take 6.45 years for the water meter company to be reimbursed for its costs in manufacturing/fabricating, shipping and delivering, and installing the smart water meter or advanced water metering technology. If the water meter company obtains $20,000,000 from the municipality than it would reduce the reimbursement period to 4.3 years.

Additionally, shown is an arrow demonstrating a water meter maintenance service 32 to provide water meter maintenance services 18 for the water municipality or water utilities. Another arrow going from the water meter company 36 to maintenance 18 shows compensation ($) 34 provided to the water meter company 36 for maintenance services. This represents that money is added to the monthly water bill, or paid directly, for providing water meter maintenance services 5.

Since smart water meters or advanced water metering technology have innovative technology, such as software updates, battery replacement, replacing nonfunction components can be a service of the water company or a designated company. This will also generate income for the water company. The method includes that the water meter company to negotiate with water municipalities or water utility to become responsible for the maintenance 18 of water meters or advanced water metering technology and its associated technology by residences and corporation operations. This will generate income for the meter company. For example, if providing maintenance services 18 and the meter company is allowed by the water municipality or water utility governing agency to increase each bill for $1.00 generating each monthly bill. It is anticipated that the payment might be paid directly from the water municipality or water utility as they have ownership rights and maintenance responsibilities for the installed smart water meter. So then for a municipality of 200,000 home residences and corporations would generate $200,000 minus cost of conduct the maintenance services. If the expense of performing the maintenance service is $50,000, then the water company will profit $150,000 per month or $1,800,000 per year. At this rate, if no other compensation is obtained (e.g. an investment by the municipality of $20,000,000 to pay for the smart meters advanced water metering technology and installation cost to promote water conservation), it would take 33.3 year for the water meter company to be reimbursed for its costs in manufacturing/fabricating, shipping and delivery, and installing the smart water meter or advanced water metering technology. If the water meter company obtains $20,000,000 from the municipality than it would reduce the reimbursement period to 22.2 years.

By adding the $1,800,000 profit by conducting the billing services, the $1,500,000 for leak alert services, the $6,000,000 for water quality sensor services, and the $1,800,000 for maintenance services, which amount to a profit of $11,100,000 per year. At this rate, if no other compensation is obtained (e.g. an investment by the municipality of $20,000,000 to pay for the smart meters and installation cost to promote water conservation), it would take 5.40 years for the water meter company to be reimbursed for its costs in fabricating and installing the smart water meter or advanced water metering technology. If the water meter company obtains $20,000,000 from the water municipality or water utility than it would reduce the reimbursement period to 3.6 years.

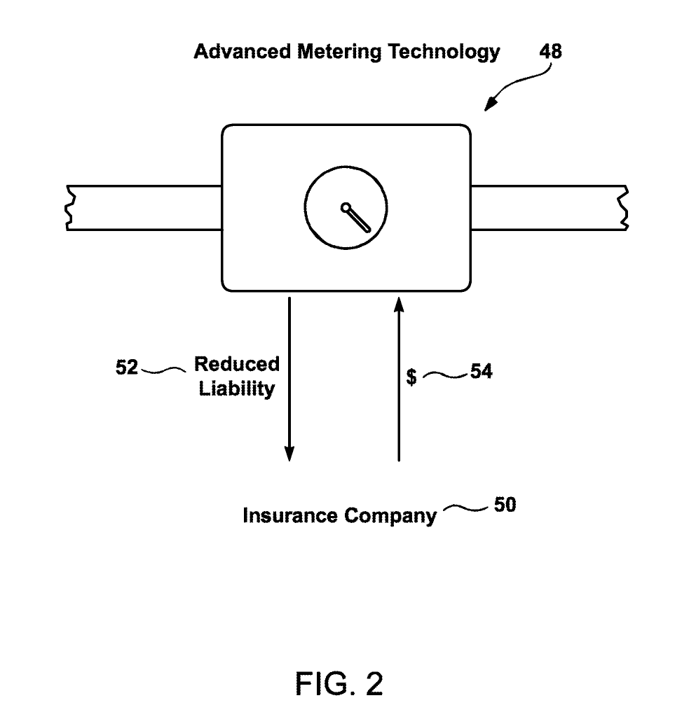

As shown in FIG. 2, insurance companies 50 have an interest in providing rebates or support financially smart water meters or advanced water metering technology 48 that minimize leak damage which reduces liability 52 and has a positive impact on the very costly insurance cost. As an example, and by assuming that the insurance company will pay 54 the water meter company $100 for each unit installed, then this would reduce the total installation cost for 200,000 home and corporations to $40,000,000.

By adding the $1,800,000 profit by conducting the billing services, if no other compensation is obtained (e.g. an investment by the municipality of $20,000,000 to pay for the smart meters or advanced water metering technology and installation cost in an attempt to promote water conservation), it would take 22.2 years for the water meter company to be reimbursed for its costs in fabricating and installing the smart water meter or advanced water metering technology. If the water meter company obtains $20,000,000 from the water municipality or water utility than it would reduce the reimbursement period to 11.1 years.

By adding the $1,800,000 profit by conducting the billing services to the $1,500,000 for providing leak alert services amounts to a profit of $3,300,000 per year. At this rate, if no other compensation is obtained (e.g. an investment by the municipality of $20,000,000 to pay for the smart meters or advanced water metering technology and installation cost to promote water conservation), it would take 12.2 years for the water meter company to be reimbursed for its costs in fabricating and installing the smart water meter. If the water meter company obtains $20,000,000 from the water municipality or water utility than it would reduce the reimbursement period to 6.1 years.

By adding the $1,800,000 profit by conducting the billing services and the $1,500,000 for leak alert services to the 6,000,000 for water quality sensor services, the total profit amounts to $9,300,000 per year. At this rate, if no other compensation is obtained (e.g. an investment by the water municipality or water utility of $20,000,000 to pay for the smart meter or advanced water metering technology and installation cost to promote water conservation), it would take 4.30 years for the water meter company to be reimbursed for its costs in fabricating and installing the smart water meter or advanced water metering technology. If the water meter company obtains $20,000,000 from the municipality than it would reduce the reimbursement period to 2.1 years.

By adding the $1,800,000 profit by conducting the billing services, the $1,500,000 for leak alert services, the $6,000,000 for water quality sensor services, to the $1,800,000 for maintenance services, the total profit amounts to $11,100,000 per year. At this rate, if no other compensation is obtained (e.g. an investment by the municipality of $20,000,000 to pay for the smart meters or advanced water metering technology and installation cost to promote water conservation), it would take 3.63 years for the water meter company to be reimbursed for its costs in fabricating and installing the smart water meter. If the water meter company obtains $20,000,000 from the municipality than it would reduce the reimbursement period to 1.8 years.

These presentations of business methods, services and cost of services, and reimbursement schemes are all examples of potential repayment and revenue plans. It is anticipated by the Applicant that for each water municipality or water utility, the water meter company will need to negotiate for certain services in return for compensation, all compensation for billing services 20, for leak alert services 28, for water quality sensor services 28, for maintenance services 32, and rebates 54 by insurance company will vary either slightly or considerably. It addition, not all water meter will allow, provide, or have the need for all billing 12, leak detection and alert 14, water quality sensor 16, and maintenance services 18. Furthermore, the percentage of home and corporations participating or requesting the water quality sensor service 28 can vary considerably within certain geographic locations or local conditions. In addition, insurance rebates 54 can vary from water municipality or water utility, or from geographical location, as statistical leak damage rates can vary considerably as some homes or corporations have older structures and older plumbing components that may have a greater potential rate of leak that can cause property damage and mold health issues, plastic plumbing components that may have different rates of potential leak property damage and mold health issues, and there are numerous other considerations.

Since these are business methods to generate income, for the water company to reimburse its expenses for manufacturing/fabricating, shipping and delivery, distribution, and installation of smart water meters or advanced water metering technology. Eventually over a period, the expenses can be fully reimbursed and now the income generated can become unencumbered revenue generating profits. At this time, defined as the unencumbered period, the water municipality or water utility and the water company can re-negotiate, or as originally agreed, to reduce, or increase, the cost of billing services, leak detection and alerting services, water quality sensor services, and maintenance services.

In addition, the insurance company 50 can change it rebate policy, whether it was a one-time payment, or a continual payment while the smart water meter has the leak detection and alert capabilities. During the unencumbered revenue generating period, the insurance company can change it rebate policy accordingly.

Provide below are some examples of cost savings and reimbursement scenarios. These scenarios are only exemplary as it is anticipated that adjustments in costs, negotiations and variability in needs between water municipalities and water utilities are expected. It is anticipated that the water billing 12, leak detection or alert 14, water quality sensors 16, maintenance 18 and insurance compensation 54 can comprise a group, and any combinations of these described services in the group can occur e.g. the combination of water billing 12 and maintenance services 18, the combination of water billing 12 and leak detection and alert 14, and maintenance services 18 and any other combination.

### Cost Savings/Reimbursement Example 1

This example assumes 200,000 residential properties and $300 as the cost to manufacture and install the Water meter company Water System at a site, resulting in a sixty million-dollar ($60,000,000) project. Table 1 shows no investment by the water municipality and Table 2 shows a 25% investment by the water municipality (reduces cost to $45,000,000). As shown, the project cost is fully paid, and profits begin in year 4 and year 3 for the example with no and 25% water municipality investments, respectively.

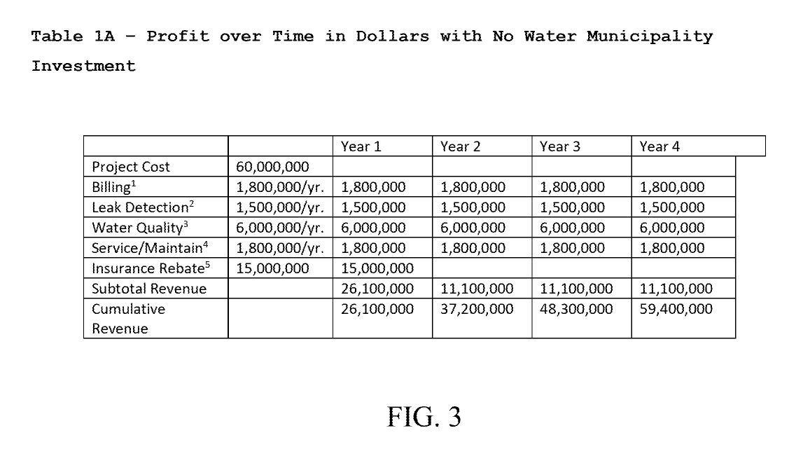

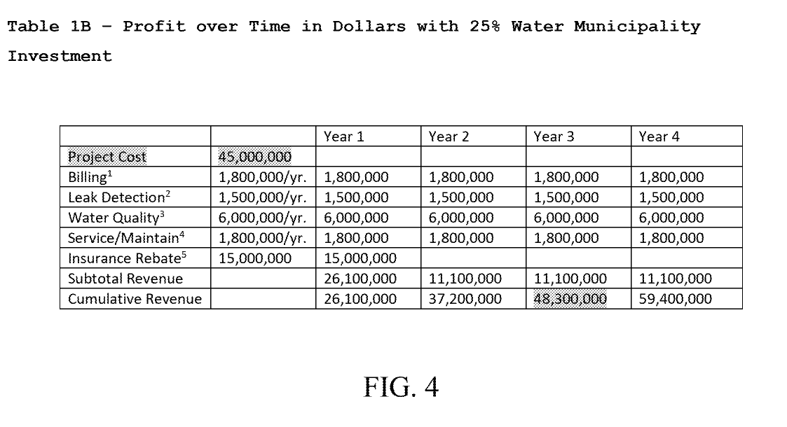

Now referring to FIGS. 3 and 4, shown are examples of water company business methods providing cost benefits.

Cost Savings/Reimbursement as shown by FIGS. 3 and 4.

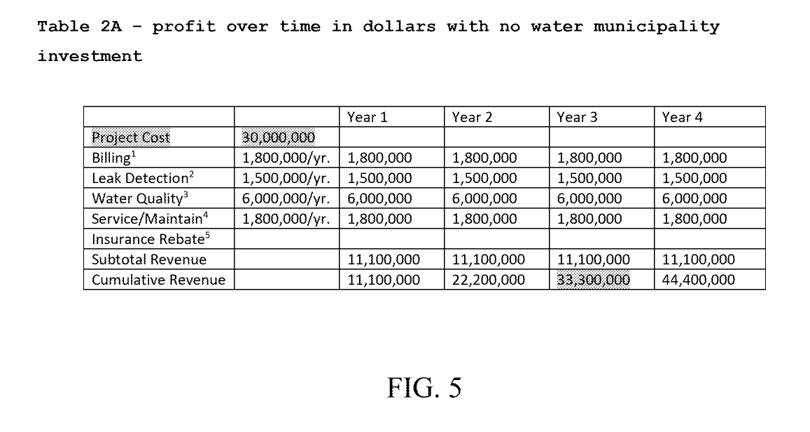

This example assumes 200,000 properties and $300 as the cost to manufacture and install the smart water meter or advanced water metering technology per property and/or company site, resulting in a sixty million-dollar ($60,000,000) project. FIG. 3 shows a Table 1A demonstrating a model with no project investment by the water municipality. FIG. 5 shows Table 1B demonstrating a model with a 25% project investment by the water municipality reducing the project cost to $45,000,000. As shown in FIGS. 3 and 4, the project cost is fully paid, and profits begin in Year 4 and in Year 3 for the no water municipality investment and for the 25% water municipality investment models, respectively.

Both FIGS. 3 and 4 use the following data assumptions.

1. Billing: $1.00 per month charged on bill per site with an operations cost of $50,000 per month or $600,000 per year (using email instead of USPS mail would save costs).

2. Leak Detection and Alert Service: $0.75 per month charge on bill per home with an operational cost of $25,000 per month or $300,000 per year.

3. Assuming only a small percentage of 10% of the sites would select water quality sensor capability, so 20,000 homes charging $50 per month per site for sensor and installation with an operational cost of $25.00 per month per site (sensors are consumable and need to be replaced regularly). So monthly revenue is $25×20,000×12 months is 6 million per year.

4. Service/Maintenance: $1.00 per month charged on bill per home with an operational cost of 50,000 per month or 600,000 per year ((1×200,000×12)−600,000).

5. Insurance Rebate to Leak Detection and Alert Service Division: Fifteen million dollars invested by Insurance companies to offset liability associated with remedial activities for property damage caused by undetected water leaks.

Note: When the water municipality invests 25% of the total project cost=$15,000,000 (to gain real-time water use information, water loss prevention, and capability to remotely turn off or reduce the flow of water for non-paying customers, to prevent water theft, etc.), then profitability begins after Year 3 rather than Year 4.

### Cost Savings/Reimbursement Example 2

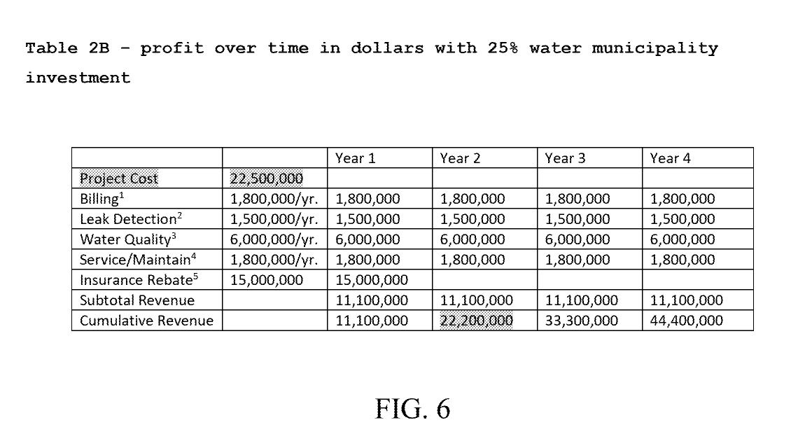

This example assumes 200,000 properties and $300 as the cost to manufacture and install the smart water meter or advanced water metering technology per site with half the cost paid by one or more insurance companies, resulting in a thirty million-dollar ($30,000,000) project. FIG. 5 shows a Table 2A demonstrating a model with no project investment by the water municipality. FIG. 6 shows a Table 2B demonstrating a model with a 25% project investment by the water municipality reducing the project cost to $22,500,000. As shown in FIGS. 5 and 6, the project cost is fully paid, and profits begin in Year 3 and in early Year 3 for the no water municipality investment and for the 25% water municipality investment models, respectively.

Both FIGS. 5 and 6 use the following data assumptions.

1. Billing: $1.00 per month charged on bill per site with an operations cost of $50,000 per month or $600,000 per year (using email instead of USPS mail would save costs).

2. Leak Detection and Alert Service: $0.75 per month charge on bill per home with an operational cost of $25,000 per month or $300,000 per year.

3. Assuming only a small percentage of 10% of the sites would select water quality sensor capability, so 20,000 homes charging $50 per month per site for sensor and installation with an operational cost of $25.00 per month per site (sensors are consumable and need to be replaced regularly). So monthly revenue is $25×20,000×12 months is 6 million per year.

4. Service/Maintenance: $1.00 per month charged on bill per home with an operational cost of 50,000 per month or 600,000 per year ((1×200,000×12)−600,000).

5. Insurance Rebate to Leak Detection and Alert Service Division: Fifteen million dollars invested by Insurance companies to offset liability associated with remedial activities for property damage caused by undetected water leaks.

Note: When the water municipality invests 25% of the total project cost=$7,500,000 (to gain real-time water use information, water loss prevention, and capability to remotely turn off or reduce the flow of water for non-paying customers, to prevent water theft, etc.), then profitability begins after Year 2 rather than Year 3.

### Cost Savings/Reimbursement Example 3

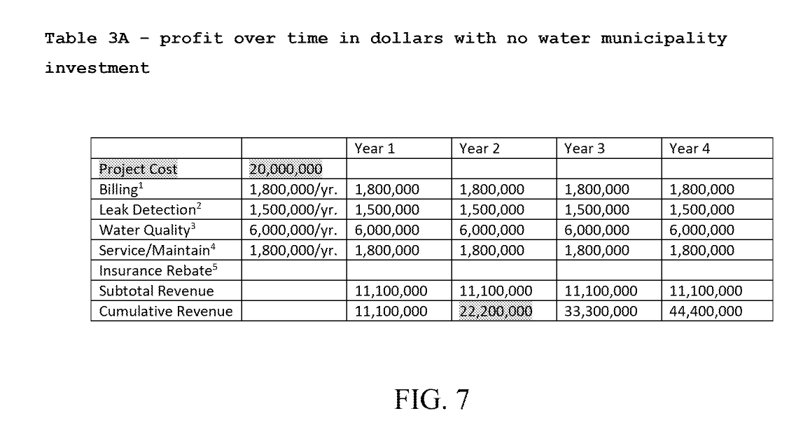

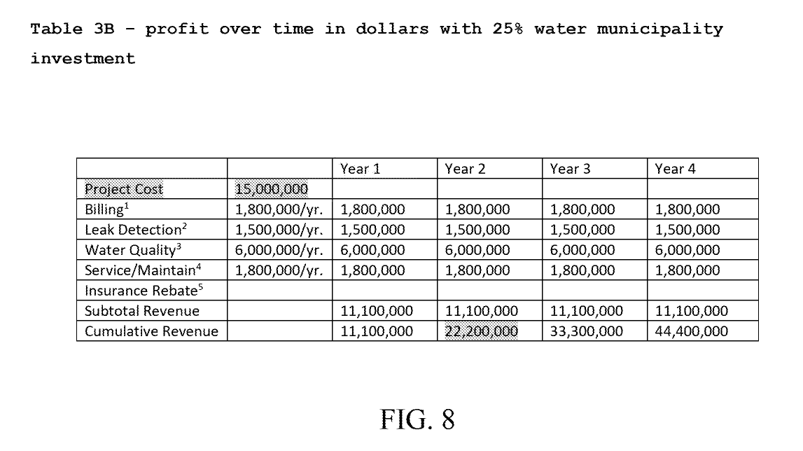

This example assumes 200,000 properties and $100 as the cost to install the smart water meter or advanced water metering technology per site (with the insurance company providing the home owner with a reduction in their policy equal to the cost of the water meter company water meter), resulting in a twenty million-dollar ($20,000,000) project. FIG. 7 shows a Table 3A demonstrating a model with no project investment by the water municipality. FIG. 8 shows a Table 3B demonstrating a model with a 25% project investment by the water municipality reducing the project cost to $15,000,000. As shown in FIGS. 7 and 8, the project cost is fully paid, and profits begin in Year 2 for the both models.

Both FIGS. 7 and 8 use the following data assumptions.

1. Billing: $1.00 per month charged on bill per site with an operations cost of $50,000 per month or $600,000 per year (using email instead of USPS mail would save costs).

2. Leak Detection and Alert Service: $0.75 per month charge on bill per home with an operational cost of $25,000 per month or $300,000 per year.

3. Assuming only a small percentage of 10% of the sites would select water quality sensor capability, so 20,000 homes charging $50 per month per site for sensor and installation with an operational cost of $25.00 per month per site (sensors are consumable and need to be replaced regularly). So monthly revenue is $25×20,000×12 months is 6 million per year.

4. Service/Maintenance: $1.00 per month charged on bill per home with an operational cost of 50,000 per month or 600,000 per year ((1×200,000×12)−600,000).

5. The insurance rebate to property owner for installing the water meter company water meter with leak detection capability offsets liability associated with property damage due to undetected leaks. (The rebate equals $200 per water meter company water meter; therefore, project costs are calculated for installation only).

Note: When the water municipality invests 25% of the total project cost=$5,000,000 (to gain real-time water use information, water loss prevention, and capability to remotely turn off or reduce the flow of water for non-paying customers, to prevent water theft, etc.), then profitability begins before the end of Year 2.

1. A business method for a water meter company or a sponsor for advanced water metering technology to be reimbursed and generate income from water related services, comprising:
installing one or more smart water meters or advanced water metering technology by a water meter company, a water municipality or and/or a water utility at one or more properties;
transferring water use data, water energy data, and/or water quality data from said one or more smart water meters or advanced water metering technology to one or more remote computers,
recording said water use data water energy data, and/or water quality data to a remote database; and
using said remote data base for calculating and preparing water use billing operations for a water municipality or water utility and/or for owners or corporative representative of one or more properties.

2. The business method for a water meter company or a sponsor for advanced water metering technology to be reimbursed and generate income from water related services as recited in claim 1, wherein installing one or more smart water meters or advanced water metering technology by a water meter company, a water municipality or and/or a water utility at one or more properties has leak detection capability.

3. The business method for a water meter company or a sponsor for advanced water metering technology to be reimbursed and generate income from water related services as recited in claim 1, wherein said rate of income generated is adjusted from the reimbursement period to an unencumbered revenue generating period.

4. The business method for a water meter company or a sponsor for advanced water metering technology to be reimbursed and generate income for water related services as recited in claim 2, wherein said generated income is augmented by insurance policy payments or rebates from the insurance company to a contracted individual that fully or partial pays for the smart water meter and/or the advanced water metering technology installation.

5. The business method for a water meter company or a sponsor for advanced water metering technology to be reimbursed and generate income for water related services as recited in claim 2, wherein said generated income from an insurance company was negotiating between the water meter company and the insurance company and optionally including a related water municipality or water utility to compensate the water meter company directly for providing and installing the smart water meter or the advance water metering technology.

6. A business method for a water meter company or a sponsor for advanced water metering technology to be reimbursed and generate income from water related services, comprising;
installing one or more smart water meters or advanced water metering technology by a water meter company, a water municipality or and/or a water utility at one or more properties;
transferring water use data, water energy data, and/or water quality data from said one or more smart water meters or advanced water metering technology to one or more remote computers,
recording said water use data water energy data, and/or water quality data to a database; and
using said data base for calculating and preparing water use billing operations for a water municipality or water utility and/or for owners or corporate representatives of one or more properties and/or;
providing leak detection and alerting operations for said home owners and corporate representatives associated with the water municipality.

7. The business method for a water meter company or a sponsor for advanced water metering technology to be reimbursed and generate income from water related services as recited in claim 6, wherein said rate of income generated is adjusted from the reimbursement period to an unencumbered revenue generating period.

8. The business method for a water meter company or a sponsor for advanced water metering technology to be reimbursed and generate income for water related services as recited in claim 7, wherein said generated income is augmented by insurance policy payments or rebates from the insurance company to a contracted individual that fully or partial pays for the smart water meter and/or the advanced water metering technology installation.

9. The business method for a water meter company or a sponsor for advanced water metering technology to be reimbursed and generate income for water related services as recited in claim 7, wherein said generated income from an insurance company was negotiating between the smart water meter company and the insurance company and optionally including a related water municipality or water utility to compensate the water meter company directly for providing and installing the smart water meter or the advanced water metering technology.

10. A business method for a water meter company or a sponsor for advanced water metering technology to be reimbursed and generate income from water related services, comprising;
installing one or more smart water meters or advanced water metering technology by a water meter company, a water municipality or and/or a water utility at one or more properties;
transferring water use data, water energy data, and/or water quality data from said one or more smart water meters or advanced water metering technology to one or more remote computers,
recording said water use data, water energy data, and/or water quality data to a database; and
using said data base for calculating and preparing water use billing operations for a water municipality or water utility and/or an owner or corporate representative of one or more properties;
providing leak detection and alerting operations for home owners and corporate representatives associated with the water municipality; and/or
providing consumable one or more water quality sensors and providing maintenance operations for replacing the one or more consumable water quality sensors.

11. A business method for a water meter company or a sponsor for advanced water metering technology to be reimbursed and generate income from water related services as recited in claim 10, wherein said rate of income generated is adjusted from the reimbursement period to an unencumbered period revenue generating period.

12. The business method for a water meter company or a sponsor for advanced water metering technology to be reimbursed and generate income for water related services as recited in claim 11, wherein said generated income is augmented by insurance policy payments or rebates from the insurance company to a contracted individual that fully or partial pays for the smart water meter and/or the advanced water metering technology installation.

13. The business method for a water meter company or a sponsor for advanced water metering technology to be reimbursed and generate income for water related services as recited in claim 11, wherein said generated income from an insurance company was negotiating between the smart water meter company and the insurance company and optionally including a related water municipality to compensate the smart water meter company directly for providing and installing the smart water meter or the advanced water metering technology.

14. A business method for a water meter company or a sponsor for advanced water metering technology to be reimbursed and generate income from water related services, comprising;
installing one or more smart water meters or advanced water metering technology by a water meter company, a water municipality or and/or a water utility at one or more properties;
transferring water use data, water energy data, and/or water quality data from said one or more smart water meters or advanced water metering technology to one or more remote computers,
recording said water use data, water energy data, and/or water quality data to a database;
using said data base for calculating and preparing water use billing operations for a water municipality or for owners or corporate representatives of one or more properties.
providing leak detection and alerting operations for home owners and corporate representatives associated with the water municipality; and/or
providing consumable water quality sensor and maintenance operations for replacing the consumable water quality sensors, and/or
performing smart water meter maintenance operations.

15. A business method for a water meter company or a sponsor for advanced water metering technology to be reimbursed and generate income from water related services as recited in claim 14, wherein said rate of income generated is adjusted from the reimbursement period to an unencumbered period revenue generating period.

16. The business method for a water meter company or a sponsor for advanced water metering technology to be reimbursed and generate income for water related services as recited in claim 15, wherein said generated income is augmented by insurance policy payments or rebates from the insurance company to a contracted individual that fully or partial pays for the smart water meter and/or the advanced water metering technology installation.

17. The business method for a water meter company or a sponsor for advanced water metering technology to be reimbursed and generate income for water related services as recited in claim 15, wherein said generated income from an insurance company was negotiating between the smart water meter company and the insurance company and optionally including a related water municipality to compensate the smart water meter company directly for providing and installing the smart water meter or the advanced water metering technology.
